(19) United States
(12) Patent Application Publication
(10) Pub. No.: US 2005/0276260 A1
(43) Pub. Date: Dec. 15, 2005

(54) Multiplex transmission device and system

(75) Inventors: Yu Chen, Taipei City (TW); Wei Tang, Taishan Township (TW)

Correspondence Address: TROXELL LAW OFFICE PLLC, SUITE 1404, 5205 LEESBURG PIKE, FALLS CHURCH, VA, 22041, US

(73) Assignees: Yu CHEN; Uniwill Computer Corp.

(21) Appl. No.: 10/958,362

(22) Filed: Oct. 6, 2004

(30) Foreign Application Priority Data
Jun. 11, 2004 (TW) 093116905

(51) Int. Cl. H04L 12/50; H04Q 11/00; H01P 1/20

(52) U.S. Cl. 370/357

(57) ABSTRACT

A multiplex transmission device and system for a host to execute selected linkage to various external devices via a fixed connecting port includes a primary circuit system integrated with a signal switch loop and signal transmission circuit; a circuit linkage comprised of a port through signal control loop in the signal switch loop and that in the primary circuit system; and the signal switch loop to judge the form of an external device according to signal level of the pin, and to output signals to conduct the circuit.

### BACKGROUND OF THE INVENTION

(a) Field of the Invention

The present invention is related to a control technology for the transmission between main circuit system of an information product such as a notebook computer, desktop computer or PDA and its external device, and more particularly to a multiplex transmission device and system that effectively reduces the number of adapted port, thus to help achieve compact design of the information product.

(b) Description of the Prior Art

Whereas the performance of an information product such as a desktop computer, notebook computer or PDA varies depending on the built-in equipment, the differences among the grades of the relative functional equipment are directly reflected on the size and pricing of the product. Therefore, additional to the built-in equipment to cater for the basic operation requirements, an information product will be also adapted with fixed type of port in relation to the peripheral for the user to select the proper external device to be incorporated to the information product via the port to upgrade the functions of the information product.

Furthermore, the Port Replicator generally available in the market is provided with a specific transmission interface. It though provides the linkage to various types of external device; a relative connection interface must be adapted to the host resulting in higher cost and larger size. However, in the normal use of the information product, many ports are actually under idling status and only limited to their specific devices if used to prevent from sharing with other devices. Accordingly, the production product of the prior art suffers unnecessary waste and frustrates the efforts in a compact design.

### SUMMARY OF THE INVENTION

The primary purpose of the present invention is to provide a multiplex transmission system for the host to link to various types of external device via a fixed port. To achieve the purpose, a signal switch loop and related signal transmission circuit are integrated into the primary circuit system. The port is linked to a circuit comprised of the signal switch loop and other related signal control loop in the primary circuit system for the signal switch loop to judge the type of the externally connected device from the level of the signal of the pin in the port of the external device, and switch the existing signal transmission circuit to output the corresponding signals to the external device for conducting the circuit between the external device and the related control loop.

Furthermore, the multiplex transmission system includes one or multiple transmission conductor. One end of the transmission conductor is connected to the port of the host and the other end is disposed with one or multiple adapter corresponding to the connecting port so that the external device operating on various input signals may execute the transmission and receiving of signals through the same port.

Accordingly, an information product configured with the multiplex transmission system of the present invention effectively reduces the number of the fixed port and simplifies the type of the fixed port to facilitate the purpose of a compact design for the information product.

### BRIEF DESCRIPTION OF THE DRAWINGS

FIG. 1 is a view showing a configuration of a first preferred embodiment of the present invention.

FIG. 2 is a schematic view showing the implementation of setup of the port of the present invention and the signal levels of the transmission conductor pins.

FIG. 3 is a flow chart of the implementation of the present invention.

FIG. 4 is a view showing a configuration of a second preferred embodiment of the present invention.

FIG. 5 is a view showing a configuration of a third preferred embodiment of the present invention.

### DETAILED DESCRIPTION OF THE PREFERRED EMBODIMENTS

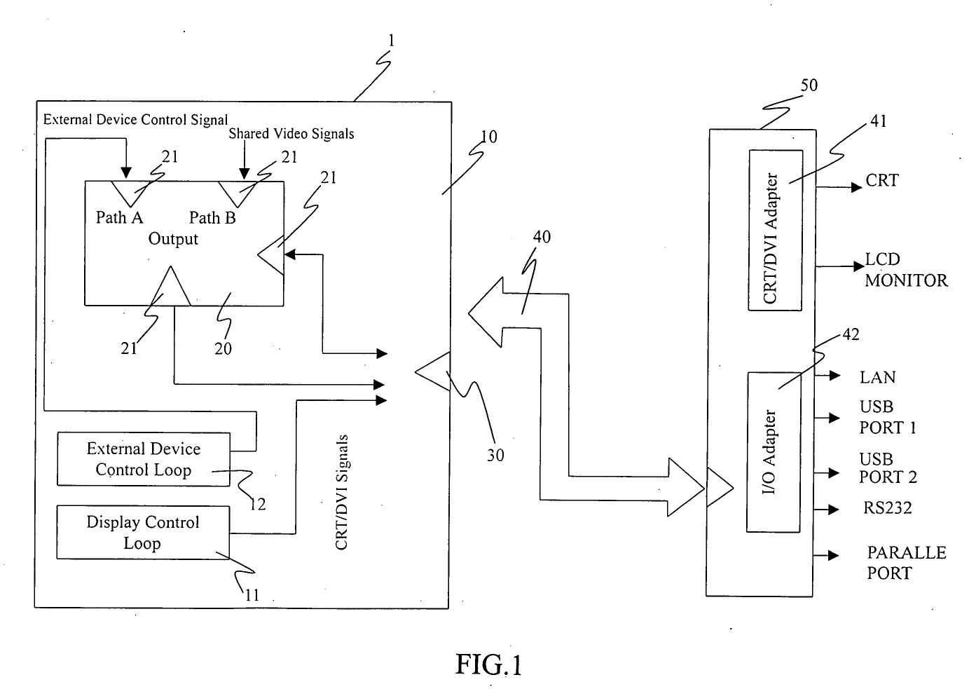

A multiplex transmission device and system of the present invention permits an external device operating on different input signals to be linked to a primary circuit system through a single fixed port. FIG. 1 shows a configuration of a first preferred embodiment of the present invention. As illustrated in FIG. 1, a host 1 in the form of a notebook computer, desktop computer or any other information product has a primary circuit system 10 integrated with a signal switch loop 20 and related signal transmission circuit 21. A video port 30 in the form of a cathode ray tube (CRT) or a digital visual interface (DVI) in the preferred embodiment is used as the port for the multiplex transmission system of the present invention. When the video port 30 is chosen to output signals to a corresponding external device 50, the signal switch loop 20 switches between signals from a display control loop 1 and a control loop 12 of an external device 50 to the corresponding external device. The display control loop 11 transmits an image display signal to the external device 50 while the control loop 12 of the external device 50 transmits the control signal to the signal switch loop 20.

The basic implementation of the multiplex transmission system of the present invention can be applied to a notebook computer. Whereas the video port 30 fixed to the notebook computer is basically reserved for the notebook computer to be connected to an external display, the video port 30 is in its idling status when the notebook computer is operating on its built-in LCD. Therefore, the video port 30 is available for the notebook computer to connect to any other external device.

The multiplex transmission device includes one or multiple transmission conductor 40. One end of the transmission conductor is connected to the video port 30 of the host 1 while the other end is connected to an external device provided with a corresponding I/O port and/or a video device of CRT/DVI. The video device of the CRT/DVI is disposed with an adapter 41 corresponding to the video port 30 for the connection to CRT or LCD, and another adapter 42 in the form of USB or LAN to connect to any other external device.

A proper spacing for the wiring material may be provided between both adapters 41, 42 to facilitate the simultaneous connection by the display to any other external device. For example, the video port 30 is provided for signal transmission/receiving between the primary circuit system 10 and the monitor, as well as other external device at the same time.

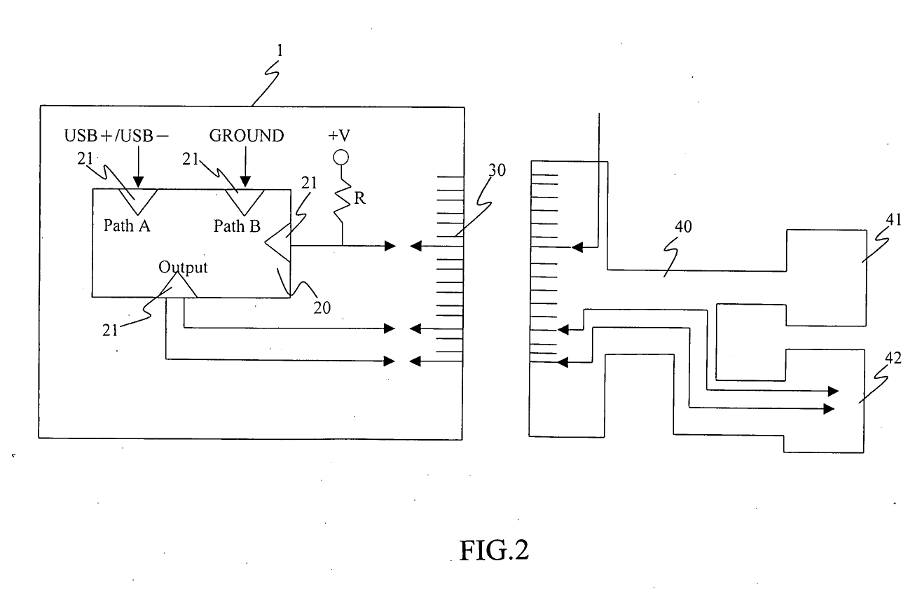

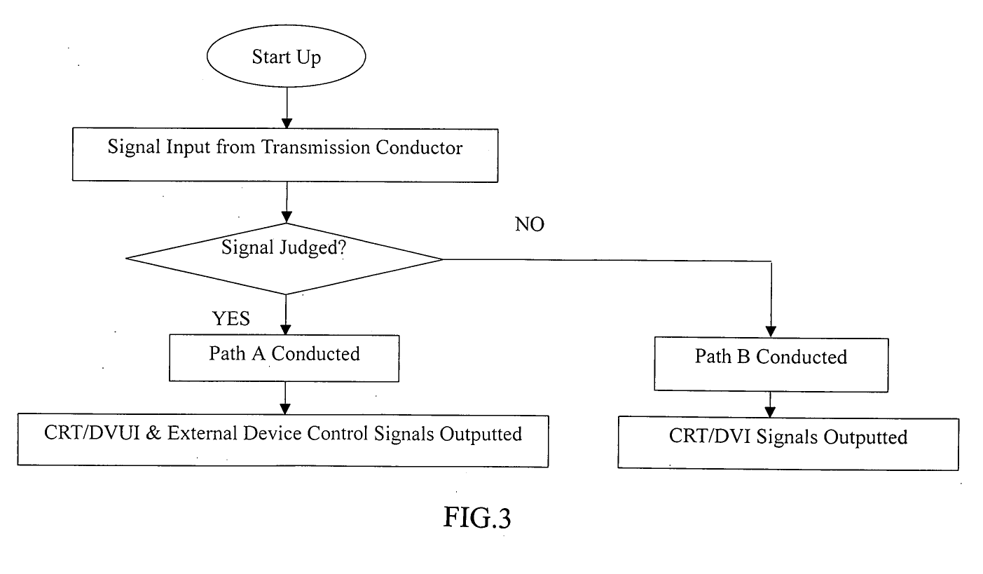

Referring to FIGS. 2, and 3 respectively showing a schematic view and flow chart for the implementation of setup of the port of the present invention and the signal levels of the transmission conductor pins in conjunction with FIG. 1, the CRT/DVI video port 30 of the host, and another pin (e.g. Ground) connected by the transmission conductor 40 are used to determine the signal level. In the preferred embodiment, Pin Ground of the CRT/DVI video port 30 is open circuit. When the transmission conductor 40 is connected to the CRT/DVI video port 30, the connected Pin Ground is conducted to indicate a high level; wherein, the signal level of Pin Ground is transmitted to the signal switch loop 20 to transmit the signal to open the control loop 12 of the external device (Path A) together with the signal from the display control loop 11 to output to the external device. On the contrary, if a traditional CRT/DVI transmission conductor is used, the video port 30 is not conducted with Pin Ground of the transmission conductor 40 to indicate a low level; wherein, the signal from the control loop 12 of the external device will not be opened (Path B), and only the signal from the display control loop 20 is outputted to the external device 50.

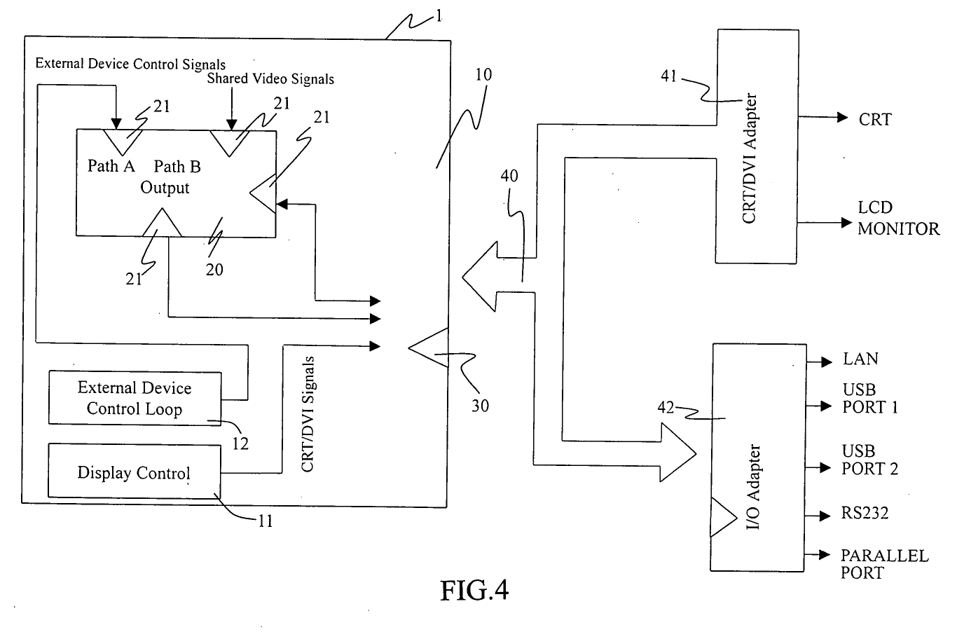

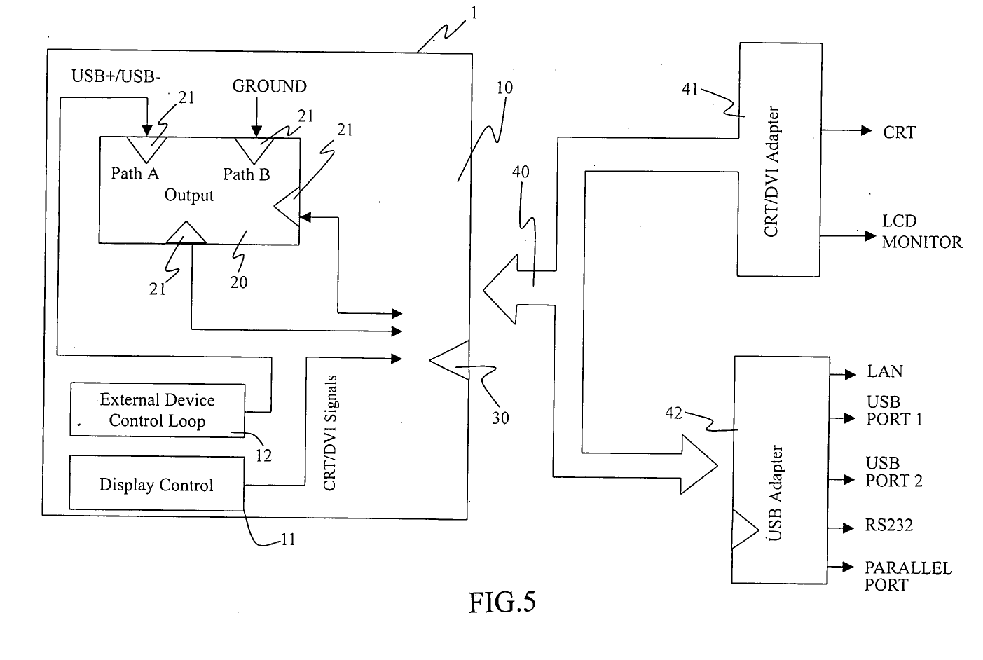

FIGS. 4 and 5 respectively show a configuration of a second and a third preferred embodiments of the present invention. While the I/O port of the external device and the video device of the CRT/DVI are integrated together as illustrated in FIG. 1, or the video device can be connected with the transmission conductor 40 and then to an external device selected by the user as desired. Or, alternatively, the I/O connector from the external device to connect to the transmission conductor 40 is related to a universal serial bus (USB) as illustrated in FIG. 5 to achieve the same multiplex transmission features.

Now referring to FIGS. 1, 2, and 3, in the multiplex transmission system of the present invention, the signal switch loop 20 determine the type of the external device connected to the video port 30 according to the signal level of the specific pin connecting the video port 30 and the transmission conductor. When the external device connected to one end of the transmission conductor 40 relates only to a monitor, the signal switch loop 20 switches then existing signal transmission circuit 21 to conduct the circuit between the monitor and the display control loop 11 in the primary circuit system 10 for the monitor to have the inputs of image signal. When any external device other than the CRT/DVI monitor is connected to one end of the transmission conductor 40, the signal switch loop 20 will automatically switch then existing signal transmission circuit 21 to conduct the circuit between the external device and the external device control loop 12 in the primary circuit system 10 for the external device to receive the corresponding output signals.

The judgment by the signal level of the pin may be achieved by means of pin voltage, analog voltage or digital encoding. Accordingly, the information product including a notebook computer, desktop computer or PDA adapted with the multiplex transmission system of the present invention effectively reduces the number of the fixed port and simplifies the type of the fixed port to facilitate the compact design of the information device. Of course, additional functions may be designed to the external device depending on the needs of the individual user.

The present invention by providing a multiplex transmission device and system to information products including notebook computer, desktop computer and PDA meets the requirements for a new patent; therefore, this application for a patent is duly filed accordingly. However, it is to be noted that any preferred embodiment and accompanying drawings disclosed do not limit the present invention, and that any construction, installation and characteristics similar or identical to those of the present invention shall be deemed as falling with the purpose and claims of the present invention.

1. A multiplex transmission device including one or multiple transmission conductor; one end of the conductor being connected to a video port of an external device; the other end of the conductor being connected to an external device and/or video device provided with a corresponding port; the video device being adapted with an adapter in relation to the video port to connect to a monitor; and one or multiple adapter disposed to the external device to connect to other device.

2. The multiplex transmission device of claim 1, wherein, the port relates to a video port in the form of a CRT.

3. The multiplex transmission device of claim 1, wherein, the port relates to a video port in the form of a DVI.

4. The multiplex transmission device of claim 1, wherein, the adapter relates to one in the form of a USB.

5. The multiplex transmission device of claim 1, wherein, the adapter relates to one in the form of a network (LAN).

6. The multiplex transmission device of claim 1, wherein, the electronic device relates to a desktop computer, notebook computer of any other information computer device.

7. A multiplex transmission system containing a host being capable of selecting among various external devices for connection to a fixed port; the port connecting an external device and a primary circuit system in a host; a signal switch loop and related signal transmission circuit being integrated into the primary circuit system; the signal switch loop being connected to other related signal control loop in the primary circuit system; the signal switch loop determining the type of the external device connected to the port by the signal level of the pin in the port; and the signal switch loop switching to conduct the circuit between the external device comprised of then existing signal transmission circuit and the related control loop.

8. The multiplex transmission system of claim 7, wherein, the multiplex transmission system including one or multiple transmission conductor; one end of the conductor being connected to the port in the host; and the other end of the conductor being disposed with one or multiple adapter in relation to the port.

9. The multiplex transmission system of claim 7, wherein, the port relates to a video port in the form of a CRT.

10. The multiplex transmission system of claim 7, wherein, the port relates to a video port in the form of a DVI.

11. The multiplex transmission system of claim 8, wherein, the port relates to a video port in the form of a USB.

12. The multiplex transmission system of claim 8, wherein, the adapter relates to one in the form of a network (LAN).

13. The multiplex transmission system of claim 7, wherein, the host relates to a desktop computer, notebook computer or any other information computer device.

14. A multiplex transmission system comprising:
a multiplex transmission device;
a primary circuit system comprised of one or multiple control loop to output control signal and/or display signal to the multiple transmission device; and
a signal switch loop to output control signal and/or display signal to the multiplex transmission device in response to the signal inputted from the multiplex transmission device.

15. The multiplex transmission system of claim 14, wherein, the multiplex transmission system further includes one or multiple signal transmission circuit serving as the signal transmission interface between the control loop and the multiplex transmission device.
